(19) United States
(12) Patent Application Publication
(10) Pub. No.: US 2007/0041768 A1
(43) Pub. Date: Feb. 22, 2007

(54) Ink ribbon, thermal transfer image forming apparatus , and method of recording print management information

(75) Inventor: Hideaki Kawada, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/496,450

(22) Filed: Aug. 1, 2006

(30) Foreign Application Priority Data
Aug. 16, 2005 (KR) 10-2005-0074926

(51) Int. Cl. B41J 33/00

(52) U.S. Cl. 400/240

(57) ABSTRACT

A method of recording print management information in a thermal transfer image forming apparatus includes applying heat to a print region using a thermal head to print the image onto a sheet, and applying heat to a header mark located next to the print region to transfer the ink layer of the header mark onto the sheet such that the print management information is recorded in the header mark and the sheet.

### CROSS-REFERENCE TO RELATED PATENT APPLICATION

This application claims the benefit under 35 U.S.C. §119(a) of Korean Patent Application No. 10-2005-0074926, filed on Aug. 16, 2005, in the Korean Intellectual Property Office, the entire disclosure of which is hereby incorporated by reference.

### BACKGROUND OF THE INVENTION

1. Field of the Invention

The present invention relates to a thermal transfer ink ribbon, a thermal transfer image forming apparatus using the same, and a method of recording print management information.

2. Description of the Related Art

A thermal transfer image forming apparatus applies heat to an ink ribbon to sublimate or melt ink and prints an image on a sheet of paper. The ink ribbon is typically contained in a cassette, which is mounted in the image forming apparatus. The ink ribbon includes a plurality of print regions, each of which corresponds to a sheet of paper. On the print region, an ink layer of predetermined color is formed. The ink ribbon winds around a supply reel and a take-up reel in the cassette.

Recently, borderless prints, such as picture prints, are being performed. The print sheet includes print regions and redundant regions. The redundant regions are provided at the lengthwise sides of the print region. Furthermore, the redundant regions may be provided at the widthwise sides of the print region. The print region and the redundant region are divided by a perforated line. An image is printed at a size slightly greater than that of the print region. When the redundant region is removed along the perforated line after printing, the borderless print is completed.

Recently, digital cameras have been selling more than conventional film cameras. Accordingly, in photo laboratories, business for printing image information stored in various recording mediums, such as a flash memory, on the sheet is being expanded instead of prints from film. Thus, print management information including customer information must be efficiently recorded and managed.

Accordingly, a need exists for a thermal transfer image forming apparatus for and a method of recording print management information in the ink ribbon and the print sheet.

### SUMMARY OF THE INVENTION

The present invention provides an ink ribbon, a thermal transfer image forming apparatus, and a method of recording print management information, which efficiently records the print management information.

According to an aspect of the present invention, an ink ribbon includes a plurality of print regions are formed that are divided to correspond to a sheet, and on which respective ink layers of predetermined colors are transferred onto the sheet by heat. A plurality of non-print regions having a high light transmittance are provided at the front ends of the print regions to divide the plurality of the print regions. Header marks are provided in the non-print regions and have low light transmittance. Additional ink layers, which have low light transmittance, which may be transferred onto the sheet by heat, are provided in the header marks.

According to another aspect of the present invention, a method of recording print management information in a thermal transfer image forming apparatus that prints an image onto a sheet using an ink ribbon includes a plurality of print regions are formed that are divided to correspond to the sheet and on which respective ink layers of predetermined colors transferred onto the sheet by heat. A plurality of non-print regions having a high light transmittance are provided at the front ends of the print regions to divide the plurality of the print regions. Header marks are provided in the non-print regions and have additional ink layers that have low light transmittance and may be transferred onto the sheet by the heat. Heat is applied to a print region using a thermal head to print the image onto the sheet. Heat is applied to the header mark located next to the print region to transfer the additional ink layer of the header mark onto the sheet such that the print management information is recorded in the header mark and the sheet.

The print management information may be recorded in a barcode form.

The sheet may include an image region corresponding to each of the print regions of the ink ribbon and redundant regions provided at the front and rear ends of the image region and divided from the image region by perforated lines. The print management information may be recorded in any one of the redundant regions.

According to another aspect of the present invention, a thermal transfer image forming apparatus includes an ink ribbon including a plurality of print regions are formed that are divided to correspond to a sheet and on which respective ink layers of predetermined colors are transferred onto the sheet by heat. A plurality of non-print regions having a high light transmittance are provided at the front ends of the print regions to divide the plurality of the print regions. Header marks are provided in the non-print regions and have additional ink layers that have low light transmittance and may be transferred onto the sheet by heat. A thermal head applies heat to the header marks and the print regions to print an image and print management information. A location sensor detects the header mark. The location sensor is located outside of a region in which the print management information is recorded.

Other objects, advantages, and salient features of the invention will become apparent from the detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 schematically illustrates a thermal transfer image forming apparatus according to an exemplary embodiment of the present invention;

FIG. 2 is an elevational view of an ink ribbon according to an exemplary embodiment of the present invention;

FIG. 3 is a top plan view of the ink ribbon of FIG. 2;

FIG. 4 schematically illustrates a printing operation using the ink ribbon of FIG. 2;

FIG. 5 is a top plan view of a color print ink ribbon according to an exemplary embodiment of the present invention;

FIG. 6 is a top plan view of a color print ink ribbon according to another exemplary embodiment of the present invention;

FIG. 7 schematically illustrates a method of recording print management information in the ink ribbon; and

FIG. 8 illustrates a print sheet having a front redundant region and a rear redundant region.

Throughout the drawings, like reference numerals will be understood to refer to like parts, components and structures.

### DETAILED DESCRIPTION OF EXEMPLARY EMBODIMENTS

Hereinafter, exemplary embodiments of the present invention are described in detail with reference to the accompanying drawings.

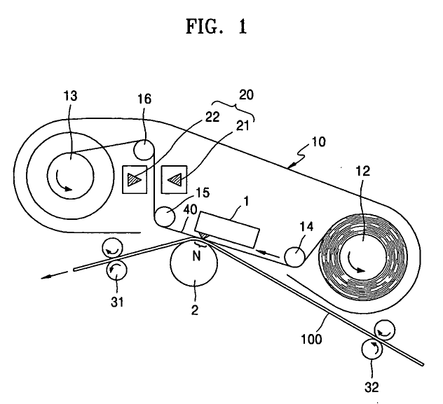

FIG. 1 schematically illustrates a thermal transfer image forming apparatus according to an exemplary embodiment of the present invention. Referring to FIG. 1, a thermal head 1 is shown. In the thermal head 1, heating elements, which can be separately controlled, are arranged in a direction substantially perpendicular to a conveying direction of a sheet of paper. A platen roller 2 faces the thermal head 1 to form a print nip N therebetween. An ink ribbon cassette 10 contains an ink ribbon 40. The ink ribbon 40 winds around a supply reel 12 and a take-up reel 13. The ink ribbon 40 between the supply reel 12 and the take-up reel 13 is guided by guide posts 14, 15, and 16. Conveying units 31 and 32 convey a print sheet 100. When the supply reel 12 and the take-up reel 13 rotate by a driving means (not shown), the ink ribbon 40 is conveyed in the same direction as a conveying direction of the sheet 100.

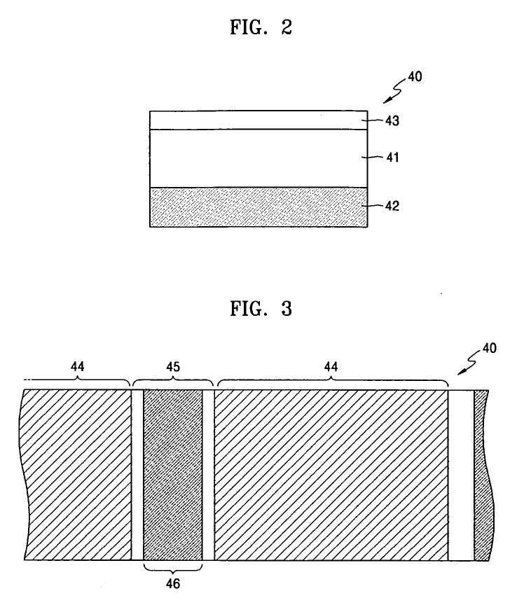

The ink ribbon 40 and the sheet 100 overlap each other and pass through the print nip N. FIG. 2 is an elevational view of the ink ribbon 40. Referring to FIG. 2, an ink layer 42 having predetermined color is disposed on the front surface of a transparent base sheet 41, and an active heat-resistant layer 43 contacting the thermal head 1 is disposed on the rear surface of the base sheet 41.

As shown in FIG. 3, the ink ribbon 40 includes a plurality of print regions 44 and a plurality of non-print regions 45. On the plurality of the print regions 44, the respective ink layers 42 of predetermined colors are formed, which are transferred onto the sheet 100 by heat. The plurality of the non-print regions 45 have high light transmittance and are provided at front ends of the print regions 44 to divide the print regions 44. In the non-print region 45, a header mark 46 is formed having low light transmittance. The header mark 46 of an exemplary embodiment is formed by coating ink that has low light transmittance and is transferred onto the sheet 100 by heat. The length of the print region 44 corresponds to the length of the sheet 100.

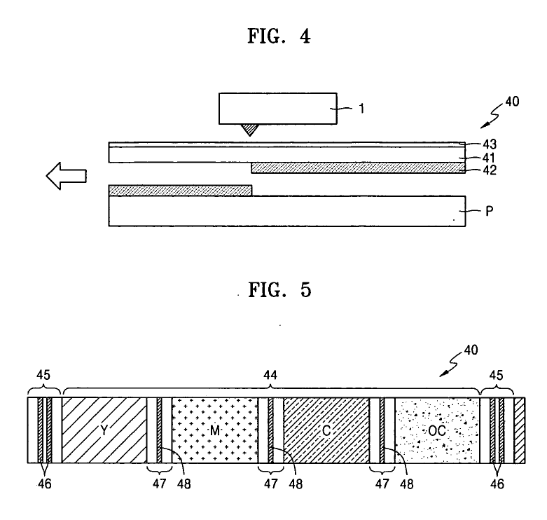

When the ink ribbon cassette 10 is mounted in the image forming apparatus, the ink ribbon 40 passes between a light emitting unit 21 and a light receiving unit 22 of an optical sensor (location sensor) 20. The image forming apparatus detects the non-print region 45 or the header mark 46 using the optical sensor 20 while winding the ink ribbon 40 toward the take-up reel 13 and recognizes a start location of the print region 44. When the front end of the print region 44 reaches the print nip N, the ink ribbon 40 stops. When the sheet 100 is fed to the print nip N, heat corresponding to image information is applied to the rear surface of the ink ribbon 40 using the thermal head 1 while conveying the sheet 100 and the ink ribbon 40. As shown in FIG. 4, the ink layer 42 is then separated from the base sheet 41 by sublimation or melting and transferred onto the sheet 100, thereby printing an image onto the sheet 100 (P in FIG. 4).

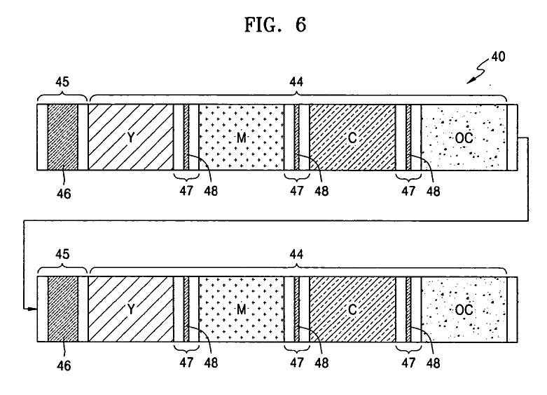

As shown in FIG. 5, a print region 44 of a color print ink ribbon 40 is divided into three color print regions Y, M, and C on which respective ink layers of yellow, magenta, and cyan are formed. The color print regions Y, M, and C are divided by the non-print regions 47. A donor mark 48 representing a start location of each of the color print regions Y, M, and C is formed in the non-print region 47. A non-print region 45 is provided at the front end of the print region 44. In the non-print region 45, a header mark 46 representing a start location of the print region 44 is provided. For example, the header mark 46 is formed in two lines and the donor mark 48 is formed in a single line. Alternatively, as shown in FIG. 6, the width of the header mark 46 may be greater than that of the donor mark 48. Additionally, the header mark 46 and the donor mark 48 may be formed in various forms such that they are distinguishable from each other. An over-coating region OC for coating the printed image may be further provided in the print region 44.

When the cassette 10 containing the ink ribbon 40 shown in FIG. 5 or 6 is mounted in the image forming apparatus, the image forming apparatus slightly winds the ink ribbon 40 and detects the header mark 46 using the optical sensor 20. The ink ribbon 40 and the sheet 100 are conveyed to a space between the platen roller 2 and the thermal head 1, such that the yellow print region Y of the ink ribbon 40 overlaps the sheet 10. The thermal head 1 applies heat corresponding to yellow image information to the ink ribbon 40 to print a yellow image onto the sheet 100. The sheet 100 is conveyed between the thermal head 1 and the platen roller 2 again by conveying the sheet 100 in a reverse direction or by conveying the sheet 100 via a conveying path (not shown), such that the cyan print region C of the ink ribbon 40 overlaps the sheet 100. The thermal head 1 applies heat corresponding to cyan image information to the ink ribbon 40 to print a cyan image onto the sheet 100. In this manner, the yellow, cyan and magenta images are overlappingly transferred onto the sheet 100. The over-coating region OC is then transferred onto the sheet 100 to improve print durability.

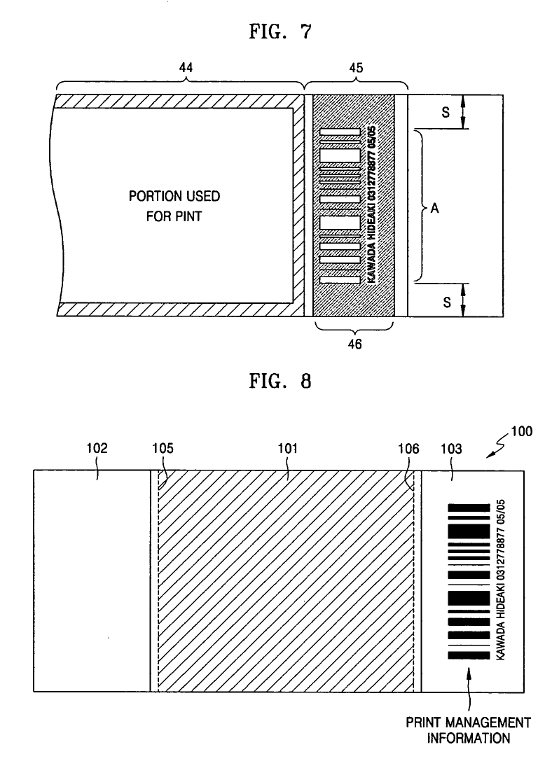

As shown in FIG. 7, when the image print is completed, a process of recording print management information starts. Because the header mark 46 is coated with ink that is transferred onto the sheet 100 by heat, the print management information is recorded in the ink ribbon 40 and ink of the header mark 46 is transferred onto the sheet 100 using the thermal head 1. The print management information is recorded in the header mark 46 located next to the print region 44. As shown in FIG. 8, the sheet 100 used in the picture print has an image region 101 and front and rear redundant regions 102 and 103. The image region 101 and the redundant regions 102 and 103 are divided by perforated lines 105 and 106. The image region 101 corresponds to the print region 44 of the ink ribbon 40. As shown in FIG. 8, the image is printed onto the image region 101 and portions of the redundant regions 102 and 103. When the redundant regions 102 and 103 are removed along the perforated lines 105 and 106 after the print is completed, a borderless print image such as a picture is obtained. According to an exemplary embodiment of the method of recording the print management information, the print management information is recorded after printing and is recorded in the rear redundant region 103 of the sheet 100.

The print management information may include, for example, a customer name, a serial number, an output date, and so forth. Also, the print management information may include the remaining amount of print sheets of the ink ribbon 40. The print management information may be recorded in a character form, a barcode form, a combination thereof, or any other suitable manner, as shown in FIGS. 7 and 8. The print management information is recorded in both the ink ribbon 40 and the sheet 100. A photo laboratory may easily manage the output sheet 100 for each customer using the print management information. Also, if necessary (for example, a customer purchases the ink ribbon 40 and consigns the ink ribbon 40 to the photo laboratory), the ink ribbon 40 may be managed for each customer. Further, the photo laboratory may develop various types of management software using the print management information. When the customer receives the output sheet 100 and removes the redundant regions 102 and 103, he or she obtains a result without the print management information.

After the print management information is recorded, the ink ribbon 40 and the sheet 100 stop before the header mark 46 reaches the optical sensor 20. In the present exemplary embodiment, the optical sensor 20 for detecting the header mark 46 to detect the start location of the print region 44 is used. To record the print management information and perform a next print, the start location of the next print region 44 must be accurately recognized by detecting the header mark 46. The optical sensor 20 may be located outside of a region A (that is, in the area indicated by S) in which the print management information is recorded, such that the optical sensor 20 does not malfunction because of the print management information recorded in the header mark 46.

As described above, according to the ink ribbon, the thermal transfer image forming apparatus, and a method of recording the print management information of exemplary embodiments of the present invention, it is possible to easily manage the sheet and the ink ribbon that are output for each customer by recording the print management information in the ink ribbon and the sheet and to develop various types of management software.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An ink ribbon, comprising:
a plurality of print regions divided to correspond to a sheet and on which respective ink layers are formed of predetermined colors to be transferred onto the sheet by heat;
a first plurality of non-print regions having a high light transmittance provided at front ends of the print regions to divide the plurality of print regions; and
a plurality of header marks provided in the non-print regions and having low light transmittance, wherein additional ink layers having low light transmittance are provided in the plurality of header marks and are adapted to be transferred to the sheet by heat.

2. A method of recording print management information in a thermal transfer image forming apparatus that prints an image onto a sheet using an ink ribbon including a plurality of print regions that are divided to correspond to the sheet and on which respective ink layers are formed of predetermined colors to be transferred onto the sheet by heat, a plurality of non-print regions having a high light transmittance are provided at the front ends of the print regions to divide the plurality of print regions, and header marks are provided in the non-print regions that have additional ink layers that have low light transmittance and are transferred onto the sheet by heat, comprising the steps of
applying heat to a print region using a thermal head to print the image onto the sheet; and
applying heat to the header mark located adjacent the print region to transfer the additional ink layer of the header mark onto the sheet such that the print management information is recorded in the header mark and the sheet.

3. The method according to claim 2, further comprising
recording the print management information in a barcode form.

4. The method according to claim 2, wherein
the sheet includes an image region corresponding to each of the print regions of the ink ribbon, and redundant regions provided at the front and rear ends of the image region and divided from the image region by perforated lines, and the print management information is recorded in any one of the redundant regions.

5. A thermal transfer image forming apparatus, comprising:
an ink ribbon including
a plurality of print regions divided to correspond to a sheet and on which respective ink layers are formed of predetermined colors to be transferred onto the sheet by heat;
a plurality of non-print regions having a high light transmittance are provided at front ends of the print regions to divide the plurality of print regions; and
a plurality of header marks provided in the non-print regions having additional ink layers having low light transmittance adapted to be transferred onto the sheet by heat;
a thermal head for applying heat to the header marks and the print regions to print an image and print management information; and
a location sensor for detecting the plurality of header marks,the location sensor being located outside of a region in which the print management information is recorded.

6. The apparatus according to claim 5, wherein
the location sensor is an optical sensor.

7. The apparatus according to claim 5, wherein
each of the plurality of print regions has a second plurality of non-print regions.

8. The apparatus according to claim 7, wherein
the second plurality of non-print regions separate print regions of different colors.

9. The apparatus according to claim 8, wherein
each of the plurality of print regions has an overcoat region formed adjacent a rearmost non-print region of the second plurality of non-print regions.

10. The apparatus according to claim 5, wherein
the print management information is recorded in the first plurality of non-print regions.

11. The apparatus according to claim 5, wherein
the print management information is recorded in barcode form.

12. An ink ribbon, comprising:
a base sheet;
a heat resistant layer disposed on a first surface of the base sheet;
an ink layer disposed on a second surface of the base sheet, the ink layer having a plurality of print regions and a first plurality of non-print regions;
the plurality of print regions being divided to correspond to a printing sheet and are transferable onto the printing sheet by heat;
the first plurality of non-print regions having high light transmittance and being disposed at front ends of each of the print regions to divide the plurality of print regions; and
a plurality of header marks formed in the first plurality of non-print regions and having low light transmittance, wherein additional ink layers having low light transmittance are formed in the plurality of header marks and are adapted to be transferred to the printing sheet by heat.

13. The ink ribbon according to claim 12, wherein
each of the plurality of print regions has a second plurality of non-print regions.

14. The ink ribbon according to claim 13, wherein
the second plurality of non-print regions separate print regions of different colors.

15. The ink ribbon according to claim 14, wherein
each of the plurality of print regions has an overcoat region formed adjacent a rearmost non-print region of the second plurality of non-print regions.

16. The ink ribbon according to claim 12, wherein
print management information is recorded in the first plurality of non-print regions.

17. The ink ribbon according to claim 16, wherein
the print management information is recorded in barcode form.

18. An ink ribbon, comprising:
a base sheet;
a heat resistant layer disposed on a first surface of the base sheet;
an ink layer disposed on a second surface of the base sheet, the ink layer having a plurality of print regions and a first plurality of non-print regions;
the plurality of print regions being divided to correspond to a printing sheet and are transferable onto the printing sheet by heat, each print region having a plurality of color print regions;
the first plurality of non-print regions having high light transmittance and being disposed at front ends of each of the print regions to divide the plurality of print regions, a second plurality of non-print regions being formed in each of the plurality of print regions such that one of the second plurality of non-print regions separates adjacent color print regions; and
a plurality of header marks formed in the first plurality of non-print regions and having low light transmittance, wherein additional ink layers having low light transmittance are formed in the plurality of header marks and are adapted to be transferred to the printing sheet by heat.

19. The ink ribbon according to claim 18, wherein
each of the plurality of print regions has an overcoat region formed adjacent a rearmost non-print region of the second plurality of non-print regions.

20. The ink ribbon according to claim 18, wherein
print management information is recorded in the first plurality of non-print regions.

21. The ink ribbon according to claim 20, wherein
the print management information is recorded in barcode form.

22. The ink ribbon according to claim 18, wherein
each of the second plurality of non-print regions has a donor mark indicating a start location of the following color print region.
